(19) United States
(12) Patent Application Publication
(10) Pub. No.: US 2025/0015302 A1
(43) Pub. Date: Jan. 9, 2025

(54) SOLID-STATE BATTERY

(71) Applicant: TOYOTA JIDOSHA KABUSHIKI KAISHA, Aichi-ken (JP)

(72) Inventors: Masatsugu KAWAKAMI, Sunto-gun (JP); Takuya MATSUYAMA, Susono-shi (JP); Tetsuya WASEDA, Bunkyo-ku (JP); Koki MATSUSAKI, Mishima-shi (JP)

(21) Appl. No.: 18/748,100

(22) Filed: Jun. 20, 2024

(30) Foreign Application Priority Data
Jul. 4, 2023 (JP) 2023-110340

(51) Int. Cl. H01M 4/66; H01M 10/0525; H01M 10/0562

(52) U.S. Cl. CPC H01M 4/667; H01M 4/661; H01M 4/668; H01M 10/0525; H01M 10/0562; H01M 2300/008

(57) ABSTRACT

A solid-state battery includes: a first current collector that includes a first metal layer and a first resin layer containing a resin and a conductive material; a first active material layer; a solid-state electrolyte layer; a second active material layer, and a second current collector that includes a second metal layer and a second resin layer containing a resin and a conductive material, which are layered in this order, wherein the first current collector is provided with the first resin layer at a first active material layer side, and the second current collector is provided with the second resin layer at a second active material layer side.

### CROSS-REFERENCE TO RELATED APPLICATION

This application is based on and claims priority under 35USC 119 from Japanese Patent Application No. 2023-110340, filed on Jul. 4, 2023, the disclosure of which is incorporated by reference herein.

### TECHNICAL FIELD

The present disclosure relates to a solid-state battery.

### RELATED ART

In recent years, secondary batteries such as lithium-ion secondary batteries have been suitably used for, for example, portable power sources for personal computers, portable terminals, and the like, and for vehicle-driving power sources for electric vehicles (EVs), hybrid vehicles (HVs), plug-in hybrid vehicles (PHVs), and the like.

In secondary batteries, since electrolytic solutions containing combustible organic solvents are used, it is necessary to install a safety device that controls temperature rise during short circuiting and to improve the structure and material surfaces for preventing short circuiting. In this regard, in a solid-state battery in which the material thereof is made to be a solid material by using a solid-state electrolyte layer instead of an electrolytic solution, since a combustible organic solvent is not used in the battery, it is considered that the safety device can be simplified and that manufacturing costs and productivity are excellent.

As the current collectors of conventional solid-state batteries, a single-layer structure composed of a ceramic foil or a metal foil, or a layered body containing a ceramic foil and a metal foil has been adopted. However, in current collectors composed of conventional ceramic foils and/or metal foils, adhesion between the current collector and the active material layer is low, and the current collector may detach from the active material layer.

In recent years, from the viewpoint of weight reduction, cost reduction, and the like, development of a resin layer containing a resin as a current collector of a solid-state battery has also advanced (see, for example, Japanese Patent Application Laid-Open (JP-A) No. 2021-097018). However, the resin layer tends to have lower electron conductivity compared to current collectors composed of ceramic foils and/or metal foils.

### SUMMARY

As described above, in a solid-state battery including only one of a resin layer or a current collector containing a conventional ceramic foil or metal foil, the adhesion between the current collector and the active material layer is low or the electron conductivity is low.

In view of the above circumstances, the present disclosure addresses provision of a solid-state battery that is excellent in both adhesion between a current collector and an active material layer and electron conductivity.

Aspects according to the present disclosure include the following aspects.

<1> A solid-state battery, including: a first current collector that includes a first metal layer and a first resin layer containing a resin and a conductive material; a first active material layer; a solid-state electrolyte layer; a second active material layer, and a second current collector that includes a second metal layer and a second resin layer containing a resin and a conductive material, which are layered in this order, wherein the first current collector is provided with the first resin layer at a first active material layer side, and the second current collector is provided with the second resin layer at a second active material layer side.

<2> The solid-state battery according to <1>, further including: between the first current collector and the first active material layer, a first intermediate layer in which at least one component contained in the first active material layer and at least one component contained in the first resin layer are present in a mixed state; and between the second current collector and the second active material layer, a second intermediate layer in which at least one component contained in the second active material layer and at least one component contained in the second resin layer are present in a mixed state.

<3> The solid-state battery according to <1> or <2>, wherein: the first resin layer includes a resin layer A and a resin layer B, the second resin layer includes a resin layer C and a resin layer D, the first current collector has a three-layer structure in which the resin layer A, the first metal layer, and the resin layer B are layered in this order from the first active material layer side; and the second current collector has a three-layer structure in which the resin layer C, the second metal layer, and the resin layer D are layered in this order from the second active material layer side.

According to the present disclosure, a solid-state battery that is excellent in both adhesion between a current collector and an active material layer and electron conductivity is provided.

### BRIEF DESCRIPTION OF THE DRAWING

FIG. 1 is a cross-sectional view illustrating an embodiment of a solid-state battery of the present disclosure.

### MODES FOR CARRYING OUT THE INVENTION

Explanation follows regarding exemplary embodiments of the present disclosure. These descriptions and examples are illustrative of embodiments, and do not limit the scope of the present disclosure.

In the present disclosure, a numerical range expressed by using “(from) . . . to . . . ”, means a range in which the numerical values before and after the word “to” are included as the lower limit value and the upper limit value.

In numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. Further, in the numerical value ranges described in the present disclosure, the upper limit value or the lower limit value described in a given numerical range may be replaced with a value shown in the examples.

In the present disclosure, in a case in which there are plural substances that correspond to a given component in a composition, unless otherwise specified, the amount of the component in the composition mean the total amount of the plural substances in the composition.

In the present disclosure, a combination of two or more preferred embodiments is a more preferred embodiment.

In the expression of a group (atomic group) in the present disclosure, an expression that does not include “substituted” or “unsubstituted” encompasses a group that does not contain a substituent as well as a group that contains a substituent.

In the present disclosure, the term “layer” includes, when an area in which the layer is present is observed, in addition to a case in which the layer is formed in the entire area, a case in which the layer is formed only in part of the area.

In the present disclosure, the term “step” includes not only an independent step, but also a step that cannot be clearly distinguished from another step as long as the intended purpose of the step is achieved.

### —Solid-State Battery—

A solid-state battery according to the present disclosure is a solid-state battery in which a first current collector that includes a first metal layer and a first resin layer containing a resin and a conductive material, a first active material layer, a solid-state electrolyte layer, a second active material layer, and a second current collector that includes a second metal layer and a second resin layer containing a resin and a conductive material are layered in this order, the first current collector is provided with the first resin layer at a first active material layer side, and the second current collector is provided with the second resin layer at a second active material layer side.

According to the present disclosure, both adhesion between the current collector and the active material layer and electron conductivity are excellent. Although the mechanism of action thereof is not necessarily clear, we surmise that the mechanism may be as follows.

In the solid-state battery according to the present disclosure, both a metal foil and a resin layer are provided as a current collector, and the resin layer is provided at an active material layer side. It is conceivable that, due to this configuration, the current collector has an excellent electron conductivity, which is imparted by the metal layer, and an excellent adhesion between the active material layer and the current collector, which is imparted by the resin layer.

The solid-state battery of the present disclosure includes so-called all-solid-state batteries in which a solid-state electrolyte is used as an electrolyte, and the solid-state electrolyte may contain less than 10% by mass of an electrolytic solution with respect to the total amount of the electrolyte. Note that the solid-state electrolyte may be a composite solid-state electrolyte containing an inorganic solid-state electrolyte and a polymer electrolyte.

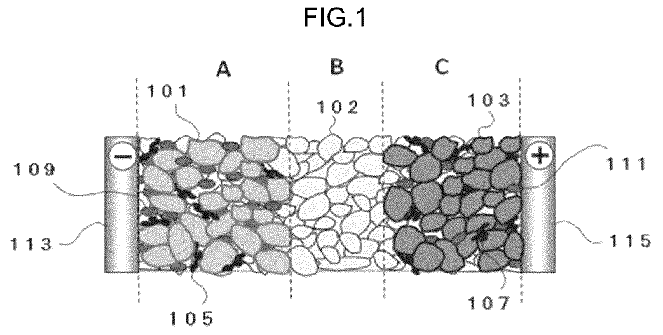

Explanation follows of an example of the solid-state battery of the present disclosure, with reference to the drawing. FIG. 1 is a schematic cross-sectional view illustrating an example of the solid-state battery of the present disclosure. The solid-state battery illustrated in FIG. 1 includes a negative electrode that includes a negative electrode current collector 113 (a first current collector) and a negative electrode active material layer A (a first active material layer), a solid-state electrolyte layer B, and a positive electrode that includes a positive electrode current collector 115 (a second current collector) and a positive electrode active material layer C (a second active material layer).

The negative electrode current collector 113 (the first current collector) is a three-layer layered body in which a first resin layer, a first metal layer, and another first resin layer are layered in this order from a negative electrode active material layer A (first active material layer) side.

The positive electrode current collector 115 (the second current collector) is a three-layer layered body in which a second resin layer, a second metal layer, and another second resin layer are layered in this order from a positive electrode active material layer C (second active material layer) side.

The negative electrode active material layer A includes a negative electrode active material 101, a conductive auxiliary aid 105, a binder 109, and a solid-state electrolyte 102. The positive electrode active material layer C includes a positive electrode active material 103, a conductive auxiliary aid 107, a binder 111, and the solid-state electrolyte 102.

In a case in which a set of the positive electrode, the solid-state electrolyte layer, and the negative electrode is assumed to be a power generation unit, the solid-state battery may include only one power generation unit or may include two or more power generation units. In a case in which the solid-state battery has two or more power generation units, the power generation units may be mutually connected in series or may be mutually connected in parallel.

In the solid-state battery, a layer-stack edge surface (that is, a side surface) of the layered structure of the positive electrode/solid-state electrolyte layer/negative electrode may be sealed with a sealing material such as a resin. The negative electrode current collector 113 and the positive electrode current collector 115 may have a configuration in which a buffer layer, an elastic layer, or a positive temperature coefficient (PTC) thermistor layer is arranged at an outer peripheral surface thereof.

The shape of the solid-state battery is not particularly limited, and may be, for example, a coin type, a cylindrical type, a square type, a sheet type, a button type, a flat type or a laminate type.

Hereinafter, for matters common to both the first current collector and the second current collector, the first current collector and the second current collector will simply be collectively referred to as the “current collector”. The first current collector and the second current collector may have the same or different layer configurations and component compositions. For example, in a case in which the type and the blending amount of the resin contained in the material, the type and the blending amount of the conductive material, and the like are different, it is considered that the component composition is different between the first current collector and the second current collector.

Hereinafter, for matters common to both the first active material layer and the second active material layer, the first active material layer and the second active material layer will simply be collectively referred to as the “active material layer”. The first active material layer and the second active material layer may have the same or different component compositions. For example, in a case in which the type and the blending amount of the active material contained in the material, the type and the blending amount of the binder, and the like are different, it is considered that the component composition is different between the first active material layer and the second active material layer.

Hereinafter, for matters common to both the first resin layer and the second resin layer, the first resin layer and the second resin layer will simply be collectively referred to as the “resin layer”. The first resin layer and the second resin layer may have the same or different component compositions. For example, in a case in which the type and the blending amount of the resin contained in the material, the type and the blending amount of the conductive material, and the like are different, it is considered that the component composition is different between the first resin layer and the second resin layer.

Hereinafter, for matters common to both the first metal layer and the second metal layer, the first metal layer and the second metal layer will simply be collectively referred to as the “metal layer” The first metal layer and the second metal layer may have the same or different component compositions. For example, in a case in which the types of metals constituting the metal foil are different, it is considered that the component composition is different between the first metal layer and the second metal layer.

Detailed explanation follows regarding each layer.

### (Current Collector)

The current collector includes a metal layer and a resin layer that contains a resin and a conductive material, and the resin layer is provided at an active material layer side.

The current collector may be a layered body of two or more layers which includes a resin layer and a metal layer, preferably a layered body of from two to four layers, and more preferably a layered body of two or three layers.

For example, the current collector preferably has a three-layer structure in which a resin layer, a metal layer, and another resin layer are layered in this order from an active material layer side. In other words, it is preferable that the first current collector has a three-layer structure in which a first resin layer, a first metal layer, and another first resin layer are layered in this order from the first active material layer side, and the second current collector has a three-layer structure in which a second resin layer, a second metal layer, and another second resin layer are layered in this order from the second active material layer side. In this case, the two first resin layers (also referred to as resin layer A and resin layer B) may have the same as or different from each other with respect to their specifics such as composition and thickness. The two second resin layers (also referred to as resin layer C and resin layer D) may have the same as or different from each other with respect to their specifics such as composition and thickness.

### Resin Layer

The resin layer includes a resin and a conductive material.

Examples of the resin include known thermoplastic resins such as poly(meth) acrylic acid, polymethyl (meth) acrylate, polyethylene, polypropylene, polyethylene terephthalate, polyether nitrile, polyimide, polyamide, polytetrafluoroethylene, polyacrylonitrile, poly(meth) acrylate, and vinyl halide resins; thermosetting resins such as epoxy resins, vinyl ester resins, unsaturated polyester resins, phenol resins, and melamine resins; and known conductive polymers such as polyaniline, polypyrrole, polythiophene, polyacetylene, polyparaphenylene, polyphenylene vinylene, polyacrylonitrile, and polyoxadiazole. The resin may be used alone or in a combination of two or more thereof.

Among these, from the viewpoint of further improving adhesion between the current collector and the active material layer, the resin preferably includes at least one of a thermoplastic resin or a conductive polymer, more preferably includes a thermoplastic resin, and still more preferably includes one or more resins selected from the group consisting of polymethyl (meth) acrylate, poly(meth) acrylic acid, and polyacrylonitrile.

In the present disclosure, “(meth) acrylic acid” is a concept that encompasses both acrylic acid and methacrylic acid, and “(meth) acrylate” is a concept that encompasses both acrylate and methacrylate.

The resin may be any of a crystalline resin, an amorphous resin, or a mixture of both, and is preferably an amorphous resin from the viewpoint of further suppressing detachment of the active material layer from the resin layer. Note that “crystalline”, in terms of a resin, means that in differential scanning calorimetry (DSC measurement), the half-value width has an endothermic peak within 10° C. when measured at a heating rate of 10 (° C./min). On the other hand, “amorphous”, in terms of a resin, means that the half-value width exceeds 10° C., or that a clear endothermic peak is not observed.

The softening temperature of the resin varies depending on the type of resin, but from the viewpoint of strength as a resin layer and the viewpoint of suppressing deterioration of the active material, for example, it is preferable that the softening temperature of the resin be lower than or equal to the crystallization temperature of the solid-state electrolyte that is contained in the solid-state electrolyte layer, which is described below. Note that the softening temperature of the resin is determined from the DSC curve that is obtained by differential scanning calorimetry (DSC).

Examples of the conductive material include carbon materials, conductive polymers, metal particles, and the like.

Examples of the carbon materials include particulate carbon materials, fibrous carbon materials, and the like. Examples of the particulate carbon materials include graphite, acetylene black (AB), Ketjen black (KB), and the like. Examples of the fibrous carbon materials include carbon nanotubes (CNTs), carbon nanofibers (CNFs), vapor-grown carbon fibers (VGCFs), and the like.

Examples of the conductive polymers include polythiophene, polyacetylene, polyparaphenylene, polyisothianaphthene, and the like.

Examples of the metal particles include particles of nickel, particles of copper, particles of iron, particles of stainless steel, and the like.

Among these, from the viewpoint of further improving adhesion between the current collector and the active material layer, and from the viewpoint of further improving the electron conductivity of the current collector, the conductive material preferably includes at least one of a carbon material or a fibrous carbon material, and more preferably includes at least one of acetylene black (AB) or a vapor-grown carbon fiber (VGCF).

From the viewpoint of further improving adhesion between the current collector and the active material layer, and from the viewpoint of further improving electron conductivity of the current collector, the content of the conductive material is preferably greater than or equal to 10% by mass and less than or equal to 50% by mass, more preferably greater than or equal to 15% by mass and less than or equal to 43% by mass, and still more preferably greater than or equal to 15% by mass and less than or equal to 35% by mass, with respect to the total solid content of the resin layer.

The resin layer may further contain a material other than a resin and a conductive material. Examples of other materials, in addition to the binder, include a dispersing agent, which improves the dispersibility of the conductive auxiliary aid in the slurry, and a wetting agent, which improves the wettability between the foil and the slurry.

From the viewpoint of further improving the electron conductivity of the current collector, the coefficient of linear expansion of the resin layer is preferably greater than or equal to 100×10⁻⁶ ppm/K and less than or equal to 500×10⁻⁶ ppm/K, more preferably greater than or equal to 200×10⁻⁶ ppm/K and less than or equal to 430×10⁻⁶ ppm/K, and still more preferably greater than or equal to 230×10⁻⁶ ppm/K and less than or equal to 350 ×10⁻⁶ ppm/K. The value of the coefficient of linear expansion is a value that is measured by a method according to JIS H7404-1993.

Although the method of setting the coefficient of linear expansion of the resin layer within the above-described range is not particularly limited, for example, a method in which the resin in the resin layer is a suitable resin as described above can be cited.

Although the thickness of the resin layer is not particularly limited, it is desirable that the resin layer is as thin as possible from the viewpoint of, for example, the energy density of the battery. From the viewpoint of further improving adhesion between the current collector and the active material layer, for example, the thickness of the resin layer is preferably greater than or equal to 5 μm and less than or equal to 80 μm, more preferably greater than or equal to 10 μm and less than or equal to 50 μm, and still more preferably greater than or equal to 10 μm and less than or equal to 30 μm.

The thickness of the resin layer is an average value of thicknesses obtained by observing a layer-stack cross-section cut in the thickness direction of the resin layer using a scanning electron microscope (SEM) with an energy dispersive X-ray spectrometer (EDX), and measuring thicknesses at freely selected 10 points.

The method used for forming the resin layer is not particularly limited. For example, in a case in which the resin is thermoplastic, the method may be a method in which a coating liquid containing a resin and a conductive material is coated and dried and molded, and in a case in which the resin is thermosetting, the method may be a method in which a raw material, such as a resin precursor or a monomer, and a conductive material are put in a mold, heated, and solidified.

From the viewpoint of further improving adhesion between the current collector and the active material layer, the resin layer, that is, the first current collector and the second current collector, has a compressive strength of preferably less than or equal to 450 MPa, more preferably less than or equal to 400 MPa, and still more preferably greater than or equal to 100 MPa and less than or equal to 400 MPa.

The compressive strength of the resin current collector is determined as follows. Plural sheets of a resin current collector are layered to prepare a test piece. When the test piece is compressed by a uniaxial press machine, the compressive strength when plastic deformation starts (that is, 5% deformation) is defined as the compressive strength. Note that in a case in which the test piece is broken before 5% deformation, the maximum strength up to breakage is defined as the compressive strength.

### Metal Layer

As the metal layer, a known material used as a metal foil can be used. Examples of the metal foil include aluminum foil, nickel foil, titanium foil, and copper foil.

The thickness of the metal layer is not particularly limited, but, for example, is preferably greater than or equal to 1 μm and less than or equal to 100 μm, more preferably greater than or equal to 3 μm and less than or equal to 20 μm, and still more preferably greater than or equal to 5 μm and less than or equal to 10 μm, from the viewpoint of further improving electron conductivity and further improving adhesion to the active material layer.

The ratio of the thickness (μm) of the metal layer to the entire current collector (metal layer/current collector) is not particularly limited, but, for example, is preferably greater than or equal to 1/16 and less than or equal to 15/16, more preferably greater than or equal to ⅛ and less than or equal to ⅞, and still more preferably greater than or equal to ¼ and less than or equal to ¾, from the viewpoint of further improving electron conductivity and from the viewpoint of further improving adhesion to the active material layer.

### (Active Material Layer)

The active material layer contains an active material. The type of active material is not particularly limited, and known materials for each of the negative electrode and the positive electrode can be used.

The active material layer may further contain, in addition to the active material, a solid-state electrolyte, a binder, and the like, if necessary.

The thickness of the active material layer is not particularly limited, but, for example, is preferably greater than or equal to 0.1 μm and less than or equal to 100.0 μm, more preferably greater than or equal to 1.0 μm and less than or equal to 100.0 μm, and still more preferably greater than or equal to 30.0 μm and less than or equal to 100.0 μm, from the viewpoint of achieving more favorable charge and discharge characteristics and from the viewpoint of further suppressing detachment of the first current collector from the first active material layer.

The thickness of the active material layer is an average value of thicknesses obtained by observing a layer-stack cross-section cut in the thickness direction of the active material layer using a scanning electron microscope (SEM) with an energy dispersive X-ray spectrometer (EDX), and measuring thicknesses at freely selected 10 points.

### (Solid-state Electrolyte Layer)

The solid-state electrolyte layer contains a solid-state electrolyte. From the viewpoint of battery performance, the solid-state electrolyte preferably includes at least one solid-state electrolyte selected from the group consisting of sulfide solid-state electrolytes, oxide solid-state electrolytes, and halide solid-state electrolytes, and more preferably includes a sulfide solid-state electrolyte.

The sulfide solid-state electrolyte preferably contains sulfur(S) as a main anionic element, and, in addition to S, preferably further contains, for example, Li element and element A. The element A is at least one selected from the group consisting of P, As, Sb, Si, Ge, Sn, B, Al, Ga, and In. The sulfide solid-state electrolyte may further contain at least one of O or a halogen element. Examples of the halogen element (X) include F, Cl, Br, I, and the like. The composition of the sulfide solid-state electrolyte is not particularly limited, and examples include xLi₂S·(100-x) P₂S₅(70≤x≤80) and yLiI·zLiBr·(100-y-z)(xLi₂S·(1-x) P₂S₅) (0.7≤x≤0.8, 0≤y≤30, 0≤z≤30). The sulfide solid-state electrolyte may have a composition represented by the following Formula (1).

Formula (1): Li₄₋ₓGe₁₋ₓPₓS₄(0<x<1)

In Formula (1), at least a portion of Ge may be substituted with at least one selected from the group consisting of Sb, Si, Sn, B, Al, Ga, In, Ti, Zr, V, and Nb. Further, at least a portion of P may be substituted with at least one selected from the group consisting of Sb, Si, Sn, B, Al, Ga, In, Ti, Zr, V, and Nb. A portion of Li may be substituted with at least one selected from the group consisting of Na, K, Mg, Ca, and Zn. A portion of S may be substituted with halogen. The halogen is at least one of F, Cl, Br or I.

The oxide solid-state electrolyte preferably contains oxygen (O) as a main anionic element, and for example, may contain Li, element Q (Q representing at least one of Nb, B, Al, Si, P, Ti, Zr, Mo, W, or S), and O. Examples of the oxide solid-state electrolyte include a garnet-type solid-state electrolyte, a perovskite-type solid-state electrolyte, a NASICON-type solid-state electrolyte, a Li—P—O-based solid-state electrolyte, a Li—B—O-based solid-state electrolyte, and the like. Examples of the garnet-type solid-state electrolyte include Li₇La₃Zr₂O₁₂, Li₇₋ₓLa₃ (Zr₂₋ₓNbₓ)O₁₂ (0≤x≤2), Li₅La₃Nb₂O₁₂, and the like. Examples of the perovskite-type solid-state electrolyte include (Li, La) TiO₃, (Li, La)NbO₃, (Li, Sr) (Ta, Zr) O₃, and the like. Examples of the NASICON-type solid-state electrolyte include Li (Al, Ti) (PO₄)₃, Li (Al, Ga) (PO₄)₃, and the like. Examples of the Li—P—O-based solid-state electrolyte include Li₃PO₄, LIPON (a compound in which a portion of O in the Li₃PO₄ is substituted with N), and the like, and examples of the Li—B—O-based solid-state electrolyte include Li₃BO₃, a compound in which a portion of O of Li₃BO₃ is substituted with C, and the like.

As the halide solid-state electrolyte, a solid-state electrolyte containing Li, M, and X (M representing at least one of Ti, Al or Y, and X representing F, Cl or Br) is suitable. Specifically, Li_{6-3z}Y_{z}X₆ (X representing Cl or Br, and z satisfying 0<2<2), and Li_{6-(4-x)b}(Ti₁₋ₓAlₓ)_{b}F₆ (0<x<1, 0<b≤1.5) are preferable. Among Li_{6-3z}Y_{z}X₆, from the viewpoint of excellent lithium-ion conductivity, Li₃YX₆ (X representing Cl or Br) is preferable and Li₃YCl₆ is more preferable. Further, Li_{6-(4-x)b}(Ti₁₋ₓAlₓ)_{b}F₆(0<x<1, 0<b≤1.5) is preferably included together with a solid-state electrolyte such as a sulfide solid-state electrolyte from the viewpoint of suppressing oxidative decomposition of the sulfide solid-state electrolyte, for example.

The crystallization temperature of the solid-state electrolyte varies depending on the type of solid-state electrolyte to be used, but, for example, is preferably greater than or equal to 0% and less than or equal to 90%, more preferably greater than or equal to 20% and less than or equal to 85%, and still more preferably greater than or equal to 50% and less than or equal to 85%. Note that the crystallinity of the solid-state electrolyte is a value measured by an X-ray diffraction method.

### (Intermediate Layer)

It is preferable that the solid-state battery according to the present disclosure further includes, between the first current collector and the first active material layer, a first intermediate layer in which at least one component contained in the first active material layer and at least one component contained in the first resin layer are present in a mixed state. When the first intermediate layer is included, adhesion between the first active material layer and the first resin layer is further improved.

It is preferable that the solid-state battery according to the present disclosure further includes, between the second current collector and the second active material layer, a second intermediate layer in which at least one component contained in the second active material layer and at least one component contained in the second resin layer are present in a mixed state. When the second intermediate layer is included, the adhesion between the second active material layer and the second resin layer is further improved.

Hereinafter, for matters common to both the first intermediate layer and the second intermediate layer, the first intermediate layer and the second intermediate layer will simply be collectively referred to as the “intermediate layer”.

From the viewpoint of enhancing the anchor effect and further improving the adhesion between the current collector and the active material layer, the intermediate layer is preferably a layer in which at least the active material contained in the active material layer and the resin contained in the resin layer are present in a mixed state.

From the viewpoint of enhancing the anchor effect and further improving the adhesion between the current collector and the active material layer, the thickness of the intermediate layer with respect to the thickness of the resin layer (intermediate layer/resin layer) is preferably greater than or equal to 1/30 and less than or equal to ¼, more preferably greater than or equal to 1/20 and less than or equal to ⅕, and still more preferably greater than or equal to 1/10 and less than or equal to ⅙.

The thickness of the intermediate layer is not particularly limited, but, for example, is preferably greater than or equal to 0.1 μm and less than or equal to 15.0 μm, more preferably greater than or equal to 0.4 μm and less than or equal to 10.0 μm, and still more preferably greater than or equal to 0.6 μm and less than or equal to 0.8 μm, from the viewpoint of achieving more favorable charge and discharge characteristics, and from the viewpoint of enhancing the anchor effect and further improving the adhesion between the current collector and the active material layer.

The thickness of the intermediate layer is an average value of thicknesses obtained by observing a layer-stack cross-section cut in the thickness direction of the intermediate layer using a scanning electron microscope (SEM) with an energy dispersive X-ray spectrometer (EDX), and measuring thicknesses at freely selected 10 points.

The components contained in the intermediate layer can be confirmed by EDX analysis of the chemical composition of a layered cross-section cut in the thickness direction of the intermediate layer using a scanning electron microscope (SEM) with an energy dispersive X-ray spectrometer (EDX).

The method used for forming the intermediate layer is not particularly limited. For example, the intermediate layer may be formed by, 1) in a case in which the resin in the resin layer is thermoplastic, a method in which a layered body, in which the resin layer and the active material layer are layered, is heated to a softening temperature of the resin or higher and the layered body is pressed, and 2) in a case in which the resin in the resin layer is thermosetting, a method in which the precursor of the thermosetting resin and the components of the active material layer, such as the active material and the binder, are filled in a mold and heated.

### EXAMPLES

### Example 1

### (Preparation of Resin Layer)

A resin slurry (solid fraction: 9.68% by weight, solvent: 2-ethylhexanol, ratio between solid components (vinyl resin: conductive material VGCF (registered trademark)-H)=80:20% by weight, wherein VGCF (registered trademark)-H was manufactured by Resonac Corporation) was coated on Ni foil (manufactured by Fukuda Metal Foil & Powder Co., Ltd.) by a blade method using an applicator. Subsequently, the applied resin slurry was dried on a hot plate at 170° C. for 30 minutes, whereby a resin layer was formed on the Ni foil (metal layer). As a result, a current collector was obtained.

### (Preparation of Active Material Layer)

2,6-dimethyl-4-heptanone, an SBR-based binder, a solid-state electrolyte (Li₂S—P₂S₅glass ceramic), and a negative electrode active material (silicon) were charged into a polypropylene (PP) container, and the PP container was stirred for 30 seconds with an ultrasonic dispersion device (UH-50, manufactured by SMT). Next, the PP container was shaken with a shaker (TTM-1, manufactured by Sibata Scientific Technology Ltd.) for 3 minutes, and further stirred with an ultrasonic dispersion device for 30 seconds to obtain an electrode slurry. The obtained electrode slurry was coated onto the resin layer of the current collector by a blade method using an applicator. The coating film was dried on a hot plate at 170° C. for 30 minutes to form a negative electrode active material layer on the resin layer on the metal layer (Ni foil), whereby an electrode test piece (negative electrode active material layer/resin layer/Ni foil) of Example 1 was obtained.

### Comparative Example 1

An electrode test piece of Comparative Example 1 was obtained in the same manner as in Example 1, except that the conductive material VGCF (registered trademark)-H was not contained in the resin slurry.

### Comparative Example 2

An electrode test piece of Comparative Example 2 was obtained in the same manner as in Example 1, except that the resin layer was not provided on the metal layer and the negative electrode active material layer was directly formed on the metal layer.

### <Evaluation of Electron Conductivity>

For the electrode test pieces of each example, a 4-terminal probe was placed on the surface on the metal layer side and on the surface on the side opposite to the surface of the metal layer, that is, the surface on the active material layer side, at intervals of 5 cm, and the surface resistance value was measured. The results are shown in Table 1.

<Evaluation of Adhesion between Current Collector and Active Material Layer>

The electrode test piece of each example was cut into 20 mm×80 mm, and after roll press forming under the conditions of a linear pressure of 1.5 kN/cm and a temperature of 25° C., and the peel strength was measured by a T-shape peel test using a tensile testing device. Further, by visual observation, it was evaluated whether or not the current collector detached from the active material layer. The results are shown in Table 1, respectively. In Table 1, the higher the value of the peel strength, the higher the adhesion between the current collector and the active material layer.

TABLE 1

| | | | Comparative | Comparative |
|---|---|---|---|---|
| | | Example 1 | Example 1 | Example 2 |
| Type of Conductive Material | | VGCF | — | — |
| in Resin Layer | | | | |
| Thickness/μm | Metal Layer | 6 | 6 | 6 |
| | Resin Layer | 2 | 2 | — |
| | Active | 70 | 70 | 70 |
| | Material | | | |
| | Layer | | | |
| | Entire | 78 | 78 | 76 |
| | Electode | | | |
| Evaluation of Electron | | 2.5 × 10⁵ | 9.0 × 10⁶ | 2.0 × 10⁵ |
| Conductivity/Ω | | | | |
| Evaluation of | Evaluation | no | no | detachment |
| Adhesiveness | by Visual | detachment | detachment | occurred |
| | Observation | | | |
| | Peel | 0.013 | 0.006 | 0.002 |
| | Strength/N/ | | | |
| | mm | | | |

As shown in Table 1, it was found that the electrode test piece of the Example was excellent in both adhesion between the active material layer and the current collector, and electron conductivity, as compared to the electrode test pieces of the Comparative Examples.

What is claimed is:

1. A solid-state battery, comprising:
a first current collector that includes a first metal layer and a first resin layer containing a resin and a conductive material;
a first active material layer;
a solid-state electrolyte layer;
a second active material layer, and
a second current collector that includes a second metal layer and a second resin layer containing a resin and a conductive material,
which are layered in this order,
wherein the first current collector is provided with the first resin layer at a first active material layer side, and the second current collector is provided with the second resin layer at a second active material layer side.

2. The solid-state battery according to claim 1, further comprising:
between the first current collector and the first active material layer, a first intermediate layer in which at least one component contained in the first active material layer and at least one component contained in the first resin layer are present in a mixed state; and
between the second current collector and the second active material layer, a second intermediate layer in which at least one component contained in the second active material layer and at least one component contained in the second resin layer are present in a mixed state.

3. The solid-state battery according to claim 1, wherein:
the first resin layer includes a resin layer A and a resin layer B,
the second resin layer includes a resin layer C and a resin layer D,
the first current collector has a three-layer structure in which the resin layer A, the first metal layer, and the resin layer B are layered in this order from the first active material layer side; and
the second current collector has a three-layer structure in which the resin layer C, the second metal layer, and the resin layer D are layered in this order from the second active material layer side.

4. The solid-state battery according to claim 2, wherein:
the first resin layer includes a resin layer A and a resin layer B,
the second resin layer includes a resin layer C and a resin layer D,
the first current collector has a three-layer structure in which the resin layer A, the first metal layer, and the resin layer B are layered in this order from the first active material layer side; and
the second current collector has a three-layer structure in which the resin layer C, the second metal layer, and the resin layer D are layered in this order from the second active material layer side.
